(19) United States
(12) Patent Application Publication
(10) Pub. No.: US 2022/0048376 A1
(43) Pub. Date: Feb. 17, 2022

(54) POWER SUPPLY SYSTEM, AND VEHICLE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Koji YAMAGUCHI, Yokkaichi-shi (JP); Hiroki HIRAI, Yokkaichi-shi (JP); Ryoya OKAMOTO, Yokkaichi-shi (JP); Taiji YANAGIDA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 17/417,329

(22) PCT Filed: Dec. 18, 2019
(86) PCT No.: PCT/JP2019/049548

§ 371 Date: Jun. 22, 2021

(30) Foreign Application Priority Data
Dec. 26, 2018 (JP) 2018-242443

(51) Int. Cl. B60K 1/04; B60L 50/60; B60R 16/04

(52) U.S. Cl. CPC B60K 1/04; B60K 2001/0405; B60R 16/04; B60L 50/66

(57) ABSTRACT

A power supply system including: a battery; a plug receiver into which a plug of a device can be plugged in a passenger compartment of a vehicle in which an occupant of the vehicle can ride; a floor that partitions between the passenger compartment and a space under the floor of the passenger compartment, the battery being mounted in the space under the floor; and an electric wire that extends from the battery, through the floor, and to the plug receiver and that can supply electricity.

### BACKGROUND

This specification discloses technology that enables electrical power to be supplied to electrical equipment inside a vehicle.

Conventionally, technologies are known in which a plurality of batteries are installed in a vehicle. In JP-A-2008-155829, a large-capacity main battery and a small-capacity sub battery are installed in a vehicle. The main battery is installed under the floor panel of the vehicle interior, and the sub battery is arranged in the engine compartment. The main battery supplies electrical power for driving an electric motor for running the vehicle, and the sub battery is used mainly for starting an internal combustion engine.

### SUMMARY

Incidentally, in recent years, there have been increasing user demands for using devices that use electric power in the passenger compartment. Here, it is preferable to be able to supply power to the devices at the positions at which the user wants to use the devices in the passenger compartment, but depending on the relationship between the battery and the usage positions of the devices, there is a concern that the electric wire(s) connecting the battery and the passenger compartment will become long, presenting an obstacle to weight reduction of the vehicle and the reduction of the manufacturing cost.

According to an exemplary aspect of the disclosure, it is possible to shorten electric wires routed in a vehicle.

According to an exemplary aspect, a power supply system includes: a battery; a plug receiver into which a plug of a device can be plugged in a passenger compartment of a vehicle in which an occupant of the vehicle can ride; a floor that partitions between the passenger compartment and a space under the floor of the passenger compartment, the battery being mounted in the space under the floor; and an electric wire that extends from the battery, through the floor, and to the plug receiver and that can supply electricity. According to this configuration, for example, compared to a configuration in which wires are routed from a battery in the engine compartment to a plug receiver in the passenger compartment without passing through the floor, due to a positional relationship between the battery and the plug receiver, it becomes possible to shorten the length of an electric wire that connects between the battery and the plug receiver. Therefore, it becomes possible to shorten the wires that are routed in the vehicle.

The following embodiments are preferable as embodiments of the technology described herein.

The battery comprises a plurality of batteries, and the plurality of the batteries includes: (i) a drive battery that supplies electric power to a drive motor of the vehicle, and (ii) an auxiliary battery that supplies electric power of a lower voltage than that of the drive battery to an auxiliary device of the vehicle.

The plug receiver is connected to a first connector, and the first connector can be fitted together with a second connector fixed to the battery.

By so doing, the work of assembling and removing the members that form the space under the floor can be easily performed by engagement of the first connector and the second connector.

An electric power converter is provided that can convert electric power of the battery, and the power converter is arranged in the space under the floor and connected to the electric wire.

By so doing, it is possible to shorten the length of the wire when supplying electric power from the auxiliary battery to the plug receiver via the power converter and the electric wire.

The plug receiver is fixed to the floor that divides between the passenger compartment and the space under the floor.

The plug receiver is fixed to a ceiling wall of the passenger compartment, and the electric wire that passes through the floor is arranged along a side wall of the passenger compartment and connected to the plug receiver on the ceiling wall.

A vehicle is equipped with the passenger compartment and the power supply system.

According to the technology disclosed in this specification, an electric wire routed in a vehicle can be shortened.

### BRIEF DESCRIPTION OF THE DRAWINGS

FIG. 1 is a side cross-sectional view of a vehicle including a power supply system of an embodiment.

FIG. 2 is a diagram that enlarges part of an area of FIG. 1.

FIG. 3 is a diagram that enlarges an area of FIG. 1 different from the area of FIG. 2.

FIG. 4 is a plan cross-sectional view of the vehicle of the embodiment.

FIG. 5 is a cross-sectional view of a rear side of the vehicle of the embodiment.

FIG. 6 is a diagram that enlarges part of an area of FIG. 5.

FIG. 7 is a diagram that shows an electrical configuration of the power supply system.

FIG. 8 is a diagram that enlarges part of the area of FIG. 1 according to another embodiment.

### DETAILED DESCRIPTION OF EMBODIMENTS

### Embodiments

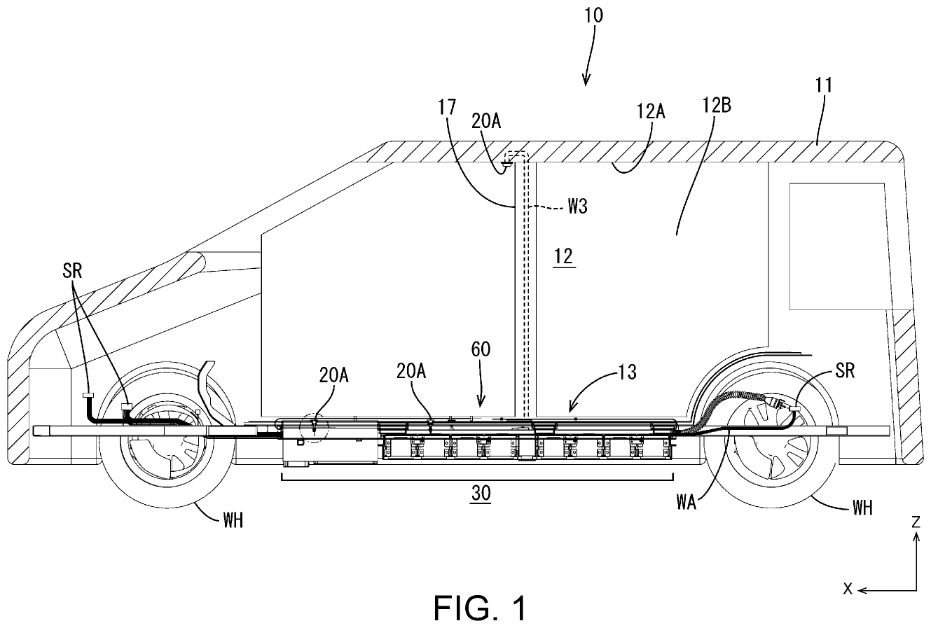

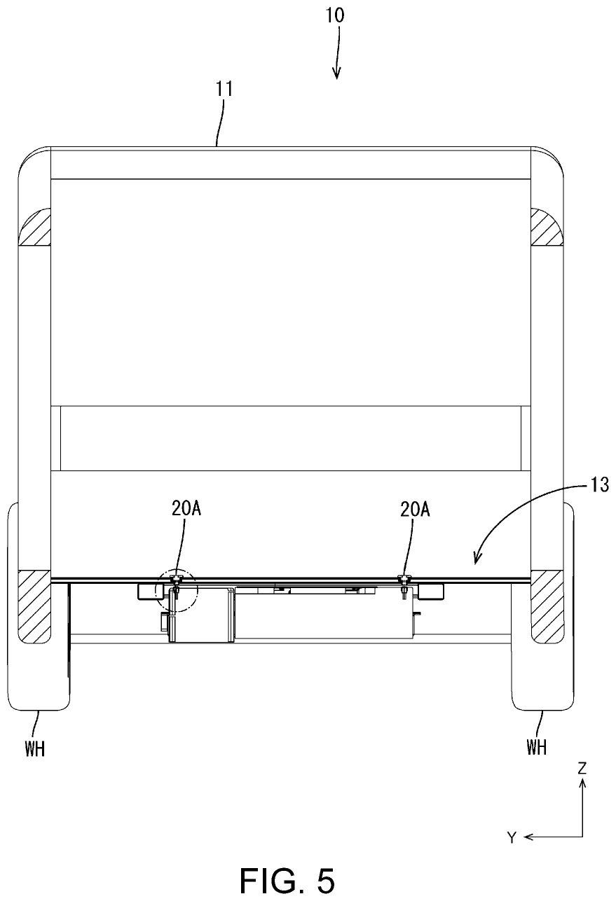

This embodiment will be explained with reference to FIGS. 1-7. A power supply system 60 of this embodiment can be applied to a vehicle 10, for example, an electric vehicle, a hybrid vehicle, or the like. Hereinafter, an X direction will described as forward, a Y direction will be described as a left side, and a Z direction will be described as upward.

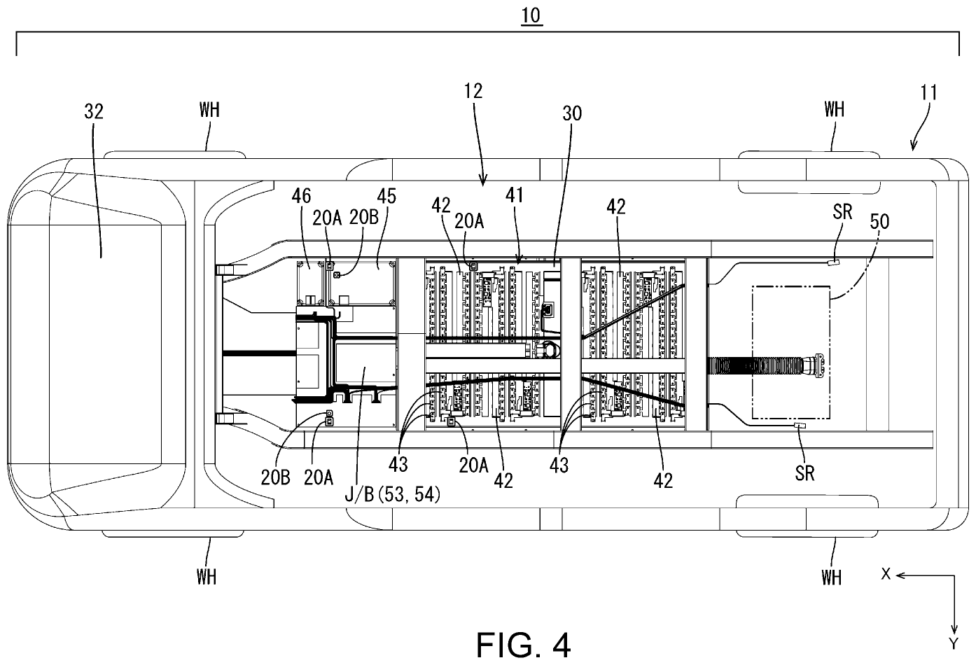

As shown in FIG. 4, the vehicle 10 is provided with (i) a vehicle body 11, (ii) a plurality of batteries 41, 45, 46, and (iii) a drive motor 50 that rotates a wheel WH to drive the vehicle 10. The vehicle body 11 is provided with (i) a passenger compartment 12 in which an occupant of the vehicle can ride, (ii) a battery compartment 30 that is arranged under the passenger compartment 12 and houses the plurality of batteries 41, 45, 46, and (iii) a storage compartment 32 (engine compartment) located in front of the passenger compartment 12 and covered with the vehicle body 11.

As shown in FIG. 1, the passenger compartment 12 is provided with a floor part 13 (floor) under undepicted seats for occupants to sit on. An upper side of the seats in the passenger compartment 12 is bounded by a ceiling wall 12A, and a left side and a right side of the seats are bounded by a side walls 12B having doors that can be opened and closed. At the side walls 12B, pillars 17 are arranged at positions for example, that separate front and rear doors. On a lower surface of the ceiling wall 12A, plug receiving parts 20A (plug recievers) are fixed that allow an occupant to insert a plug P of a household electrical device. The plug receiving parts 20A are connected to the batteries 41, 45, 46 via electric wires W3 routed within the pillars 17 (inner surface sides of the side walls 12B) of the side wall 12B. The plug receiving parts 20A can supply power to household electrical devices in a state in which plugs P are connected to the plug receiving parts 20A. The electric wires W3 within the pillars 17 pass through through holes in the floor part 13 and are connected to a power supply passage at the batteries 41, 45, 46 side.

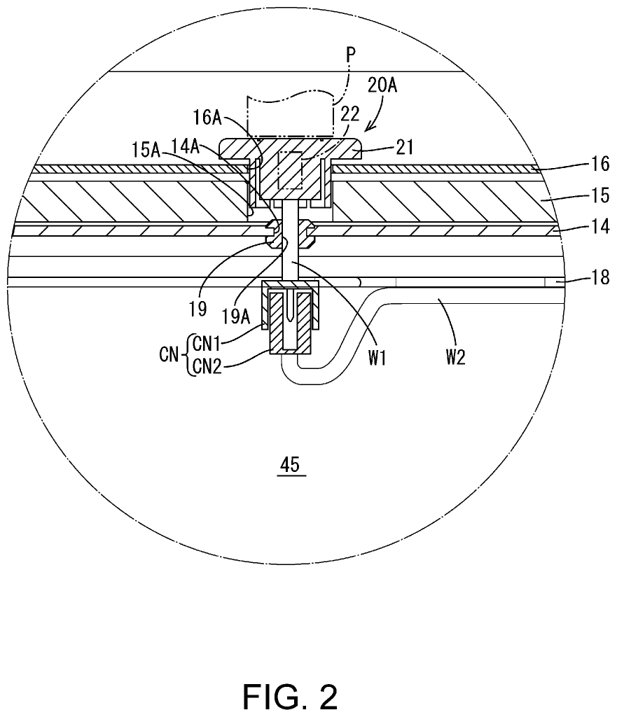

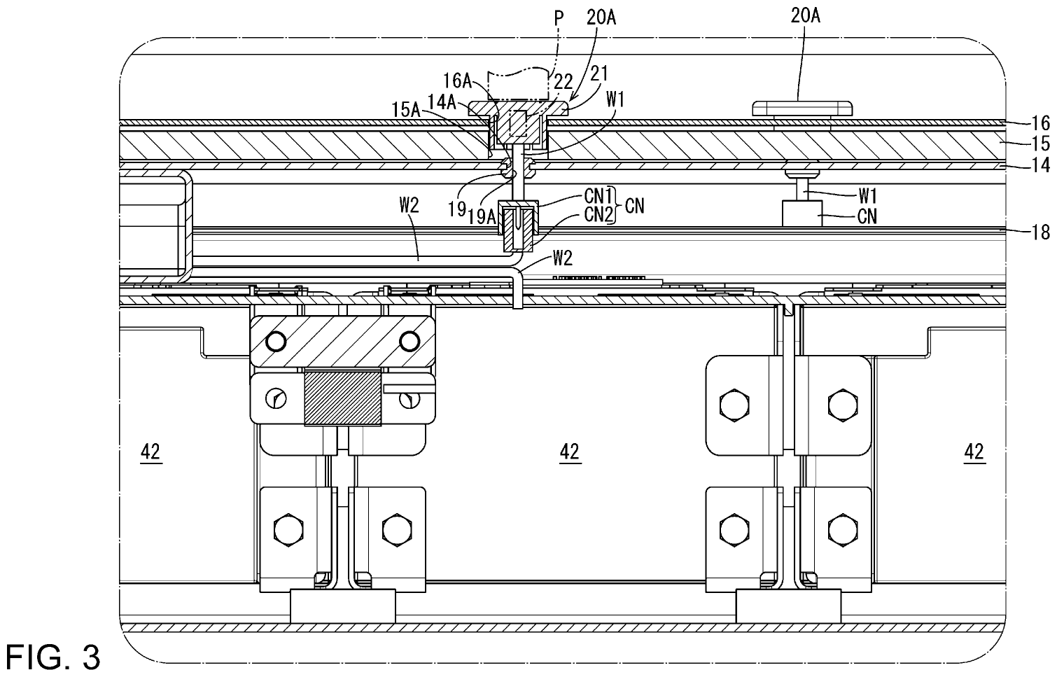

The floor part 13 separates the passenger compartment 12 from the battery compartment 30. As shown in FIGS. 2 and 3, the floor part 13 is provided with (i) a floor panel 14, (ii) a floor carpet 16 layered above the floor panel 14, (iii) a sound insulation board 15 arranged between the floor panel 14 and the floor carpet 16, and (iv) a plurality of plug receiving parts 20A, 20B (see FIG. 4) into which occupants can insert plugs of electrical devices.

Attachment holes 14A to which grommets 19 are installed are formed through the floor panel 14. As shown in FIGS. 2 and 3, mounting holes 15A and 16A for mounting the plug receiving parts 20A, 20B are formed through the sound insulation plate 15 and the floor carpet 16, respectively.

As shown in FIG. 4, the plug receiving parts 20A, 20B are provided with (i) 100V receiving parts 20A to which the plugs P of electrical devices that can be used at a voltage of 100v are connected (plugged in) and (ii) 12V receiving parts 20B to which the plugs P (for example, a cigarette lighter socket type) of electrical devices that can be used at a voltage of 12V are connected (plugged in). On the floor part 13, they are provided in multiple locations in which it is easy for an occupant to insert a plug. Specifically, for example, they can be arranged in front of or to the side of the seat in which an occupant sits. Further, in this embodiment, the 12V receiving parts 20B are arranged at locations in the vicinity of the 100V receiving parts 20A. However, it is not limited to this. Different voltage receiving parts may be provided at positions separated from each other. Additionally, the plug receiving parts 20A, 20B are not limited to the above voltages, but may be changed as needed. For example, instead of 100V receiving parts, 110-240V receiving parts according to the voltage of each country may be used.

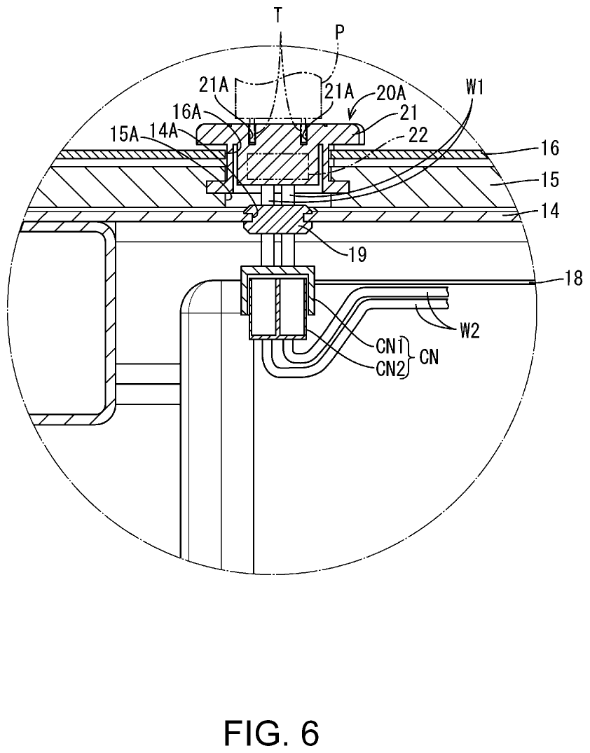

As shown in FIGS. 2 and 3, each of the plug receiving parts 20A is provided with (i) a casing 21 made of synthetic resin and (ii) a terminal part 22 arranged within the casing 21. As shown in FIG. 6, in the casing 21, a pair of insertion holes 21A is formed into which a pair of terminals T of the plug P can be plugged. The terminal part 22 can be connected to core wires, which have been exposed by removing insulating coating at ends of the electric wires, by connection means such as pressure welding. Further, the plug receiving parts 20B are substantially similar to the plug receiving parts 20A, the only difference from the plug receiving parts 20A being that the shape of each of the insertion holes 21A is different based on the specification according to the voltage difference. Thus, the description is omitted. The plug receiving parts 20A, 20B are connected to first connectors CN1 via the electric wires W1. Second connectors CN2 are attached and fixed to a cover 18 that covers the auxiliary batteries 45, 46. The second connectors CN2 are electrically connected to the auxiliary batteries 45, 46 via the electric wires W2. The first connectors CN1 and the second connectors CN2 are provided with (i) housings made of synthetic resin and (ii) male and female connector terminals that are fixed to these housings and come into contact with each other at the time of being fitted together. By fitting together the first connectors CN1 and the second connectors CN2, power of the auxiliary batteries 45, 46 is supplied to electrical devices via the plug receiving parts 20A, 20B, and the plugs P.

The electric wires W1 pass through through holes 19A of the grommets with the outer peripheral surfaces in close contact with the through holes. The grommets 19 are made of elastic material such as rubber, and their outer peripheral surfaces are in close contact with the attachment holes 14A of the floor panel 14, whereby damage of the outer periphery of the electric wires W1 is suppressed and passing of water is suppressed. Further, a configuration without the grommets 19 may be provided. In this case, for example, waterproof connectors with seals may be used. Also, as shown in FIG. 1, various sensors SR for detecting a vehicle state are attached to the vehicle body 11. A detection signal of each sensor SR is output to an ECU (Electronic Control Unit) or the like via an electric wire WA.

As shown in FIGS. 1 and 4, the battery compartment 30 accommodates the plurality of batteries 41, 45, 46 side by side within a range of substantially the same height (a range of the same layer). The plurality of batteries 41, 45, 46 are all secondary batteries and includes a drive battery 41 and auxiliary batteries 45, 46.

The drive battery 41 is a high-voltage battery (for example, 400V) and supplies power to the drive motor 50 of the vehicle 10 to drive the vehicle 10. The drive battery 41 is formed by connecting a plurality of power storage elements 42 having positive electrode terminals and negative electrode terminals in series or in parallel. The electrode terminals of the power storage elements 42 adjacent to each other in the drive battery 41 are connected by a bus bar 43 made of metal such as copper or copper alloy. For example, a lithium ion power storage battery may be used as the drive battery 41. The auxiliary batteries 45, 46 include (i) a medium voltage battery 45 (for example, 48V) and (ii) a small voltage battery 46 (for example, 12V) having lower output power than the medium voltage battery 45. The auxiliary batteries 45, 46 can use, for example, a lead battery or a condenser. For example, a lamp, a navigation device, an air conditioner, a starter motor, an alternator, a radiator, or the like can be used as an auxiliary device 56 to which the auxiliary batteries 45, 46 supply power. The storage compartment 32 accommodates the auxiliary device 56 and the like. However, in this embodiment, the drive battery 41 and the plurality of auxiliary batteries 45, 46 are not housed in the storage compartment 32.

An electrical configuration of the power supply system 60 will be explained.

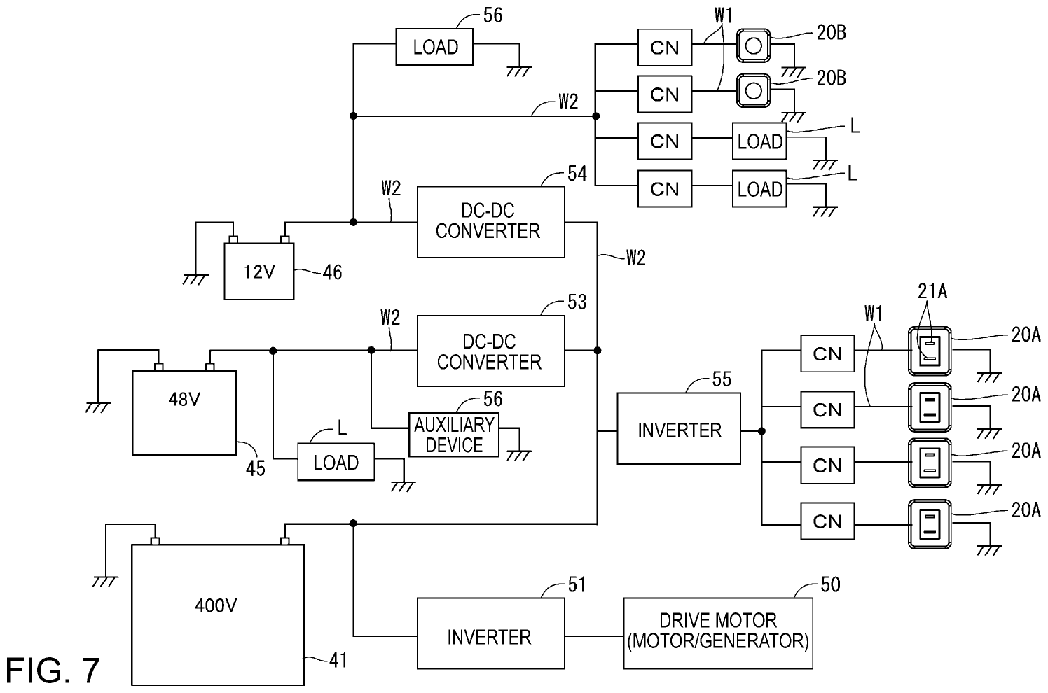

As shown in FIG. 7, the drive battery 41 (for example 400V) is connected to the drive motor 50 (motor/generator) via an inverter 51. Further, the drive battery 41 is connected to DC-DC converters 53, 54 (examples of a “power converter”) and an inverter 55. The DC-DC converters 53, 54 and the drive battery 41 are connected to each AC 100V receiving part 20A via the inverter 55 and respective connectors CN.

The auxiliary battery 45 (for example, 48V) is connected to the DC-DC converter 53 (an example of a “power converter”) and a load L (car navigation or the like). The DC-DC converter 53 is connected to the 100V receiving parts 20A via the inverter 55 and respective connectors CN. The auxiliary battery 46 (for example, 12V) is connected to the DC-DC converter 54 (an example of a “power converter”), and the DC-DC converter 54 is connected to each 100V receiving part 20A via respective connectors CN.

As shown in FIG. 7, the wires W2 drawn out above the drive battery 41 and the wires W2 drawn out above the connectors CN extend to the left and are connected to the DC-DC converter 54, and the voltage of the drive battery 41 can be converted to a 100V voltage at the DC-DC converter 54 and output from the 100V receiving parts 20A. Further, as shown in FIG. 7, the auxiliary battery 46 is connected to the 12V receiving parts 20B and a plurality of loads L via respective connectors CN (without going through a DC-DC converter). In addition, the drive battery 41 supplies power to the auxiliary batteries 45, 46 via the DC-DC converters 53, 54.

As shown in FIG. 2, the wires W2 drawn out above the auxiliary battery 45 are arranged along the lower surface of the cover 18 and connected to the connector CN. Further, the electric wires W1 are drawn out above the connector CN and connected to the plug receiving part 20A. As shown in FIG. 4, the DC-DC converters 53 and 54 are integrated with a junction box J/B that connects a number of conductive paths (electric wires) and are arranged at a side of the auxiliary battery 45, between the storage compartment 32 and the drive battery 41.

According to this embodiment, the following operations and effects are accomplished.

The power supply system 60 includes (i) batteries 41, 45, 46 mounted under the floor of the vehicle 10, (ii) plug receiving parts 20A, 20B into which plugs P of devices can be plugged, in a passenger compartment 12 in a vehicle 10 in which occupants can ride, (iii) a floor part 13 that partitions between the passenger compartment 12 and the space under the floor part 13 of the passenger compartment 12, and (iv) electric wires W1-W3 that extend from the batteries, through the floor part 13, and to the plug receiving parts 20A, 20B and can supply electricity.

According to this embodiment, for example, compared to a configuration in which electric wires are routed from a battery in the engine compartment to plug receiving parts 20A and 20B in the passenger compartment without passing through the floor part 13, it becomes possible to shorten the length of the electric wires W1-W3 that connect between the batteries 41, 45, 46 and the plug receiving parts 20A, 20B. Thereby, due to a positional relationship between the batteries 41, 45, 46 and the plug receiving parts 20A, 20B, it becomes possible to shorten the length of the electric wires W1-W3 that connect between the batteries 41, 45, 46 and the plug receiving parts 20A, 20B. Therefore, it becomes possible to shorten the electric wires W1-W3 that are routed in the vehicle 10.

In addition, the plug receiving parts 20A, 20B are connected to the first connectors CN1, and the first connectors CN1 can be fitted to the second connectors CN2 fixed to the auxiliary batteries 45 and 46.

By so doing, the work of assembling and removing the members that form the space under the floor part 13 can be easily carried out by the fitting together of the first connectors CN1 and the second connectors CN2.

Additionally, DC-DC converters 53, 54 (electric power converters) are provided that can convert electric power of the auxiliary batteries 45, 46, and the DC-DC converters 53, 54 are arranged at the space under the floor part 13 and connected to the electric wires W1-W3.

By so doing, it is possible to shorten the length of the electric wires W1-W3 when supplying electric power from the auxiliary batteries 45, 46 to the plug receiving parts 20A, 20B via the DC-DC converters 53, 54 and the electric wires W1-W3.

Additionally, the plug receiving parts 20A, 20B are fixed to the floor part 13.

By so doing, it is possible to shorten the length of the electric wires W1-W3 when supplying electric power from the auxiliary batteries 45, 46 to the plug receiving parts 20A, 20B.

### Other Embodiments

The technology described in this specification is not limited to the embodiment described by the above descriptions and drawings, and for example, the following embodiments are also included in the technical scope of the technology described in this specification.

(1) The batteries 41, 45, and 46 may be configured, for example, to receive a supply of power from a solar cell. For example, a solar panel may be installed above the ceiling wall 12A of the passenger compartment 12, and the batteries 41, 45, and 46 may be charged by the power generated by the solar panel.

(2) The positions of the auxiliary batteries 45, 46 are not limited to the space under the floor part 13 of the passenger compartment 12 and can be arranged in various positions. For example, the auxiliary batteries 45, 46 may be placed in the storage compartment in front of the passenger compartment 12, or in the passenger compartment 12.

(3) The plug receiving parts 20A and 20B are provided on the ceiling wall 12A and floor part 13 of the passenger compartment 12, but it is not limited to this, and they may be provided, for example, on an instrument panel at the front of the passenger compartment 12, or on a seat or the like.

(4) The power supply system 60 is configured to include a medium voltage battery 45 (for example, 48V), but may also be configured not to include a medium voltage battery 45.

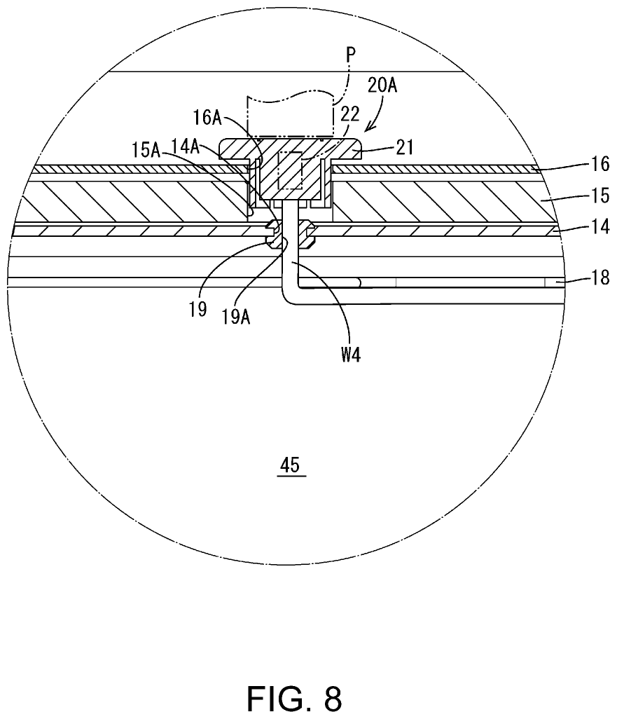

(5) A configuration was used in which the connections between the batteries 41, 45, 46 and the plug receiving parts 20A (20B) are made by electric wires W1, W2 via connectors CN, but it is not limited to this. For example, as shown in FIG. 8, a configuration may be such that the connections between the batteries 41, 45, 46 and the plug receiving parts 20A (20B) are made directly by wires W4, without including connectors CN.

1. A power supply system comprising:
a battery;
a plug receiver into which a plug of a device can be plugged in a passenger compartment of a vehicle in which an occupant of the vehicle can ride;
a floor that partitions between the passenger compartment and a space under the floor of the passenger compartment, the battery being mounted in the space under the floor; and
an electric wire that extends from the battery, through the floor, and to the plug receiver and that can supply electricity.

2. The power supply system according to claim 1, wherein:
the battery comprises a plurality of batteries, and
the plurality of batteries includes:
(i) a drive battery that supplies electric power to a drive motor of the vehicle, and
(ii) an auxiliary battery that supplies electric power of a lower voltage than that of the drive battery to an auxiliary device of the vehicle.

3. The power supply system according to claim 1, wherein the plug receiver is connected to a first connector, and the first connector can be fitted together with a second connector fixed to the battery.

4. The power supply system according to claim 1, further comprising:
an electric power converter that can convert electric power of the battery,
wherein the power converter is arranged in the space under the floor and connected to the electric wire.

5. The power supply system according to claim 1, wherein the plug receiver is fixed to the floor part.floor.

6. The power supply system according to claim 2, wherein:
the plug receiver is fixed to a ceiling wall of the passenger compartment, and
the electric wire that passes through the floor is arranged along a side wall of the passenger compartment and connected to the plug receiver on the ceiling wall.

7. A vehicle, comprising:
the passenger compartment; and
the power supply system according to claim 1.
